(19) United States
(12) Patent Application Publication
(10) Pub. No.: US 2024/0345940 A1
(43) Pub. Date: Oct. 17, 2024

(54) METHOD AND SYSTEM FOR GENERATING TEST SCRIPTS

(71) Applicant: HCL Technologies Limited, New Delhi (IN)

(72) Inventors: SOURABH PRAKASH, Bangalore (IN); RAKESH KUMAR SIDHARTHAN, Chennai (IN); SIVA SAKTHIVEL S, Chennai (IN); SUJEET KUMAR, Chennai (IN)

(21) Appl. No.: 18/609,507

(22) Filed: Mar. 19, 2024

(30) Foreign Application Priority Data
Apr. 13, 2023 (IN) 202311027481

(51) Int. Cl. G06F 11/36

(52) U.S. Cl. CPC G06F 11/3684; G06F 11/3608

(57) ABSTRACT

The method and system for generating test script from product requirements is disclosed. The method may include classifying a product requirement into a corresponding category of a plurality of predefined categories, using a first pre-trained machine learning (ML) model and obtaining a set of predefined questions corresponding to the product requirement, based on the category associated with the product requirement, from a database. The method may further include determining an answer-value corresponding to each predefined question of the set of predefined questions, using a second pre-trained machine learning (ML) model and generating a test script based on the set of predefined questions and the answer value corresponding to each question of the set of questions.

### TECHNICAL FIELD

This disclosure relates generally to test script generation, and more particularly to method and system for generating test script from product requirements, using Natural Language Processing (NLP).

### BACKGROUND

Application testing is one of the essential phases of product development. A product can be a software or web interface or any other technology that is commercially viable. Automated testing of these products has gained popularity nowadays, because of increased reliability and reduced test efforts.

However, automated functional testing involves identification of test cases, generation of test scripts, execution of the test scripts, and of reporting the test results. Traditional test script generation requires intense manual effort, and suffers from lack of test coverage and increased probability of errors. The traditional test script generation also demands product knowledge and skilled resources to develop test cases and their corresponding test scripts. Some automated test script generation (ATSG) technologies try to overcome the above problems; however, the existing ATSG techniques uses Behavior Driven Development (BDD) techniques to generate test scripts automatically from the test cases. BDD is a key word-based approach which tends to relate each keyword with a set of predefined test scripts capable of doing certain functions. However, BDD requires creation of keywords and its corresponding test scripts manually.

### SUMMARY

In an embodiment, a method of generating test script from product requirements is disclosed. The method may include classifying a product requirement into a corresponding category of a plurality of predefined categories, using a first pre-trained machine learning (ML) model and obtaining a set of predefined questions corresponding to the product requirement, based on the category associated with the product requirement, from a database. The method may further include determining an answer-value corresponding to each predefined question of the set of predefined questions, using a second pre-trained machine learning (ML) model and generating a test script based on the set of predefined questions and the answer value corresponding to each question of the set of questions.

In another embodiment, a system for generating test script from product requirements is disclosed. The system includes a processor and a memory. The memory stores a plurality of processor-executable instructions, which upon execution, cause the processor to classify a product requirement into a corresponding category of a plurality of predefined categories, using a first pre-trained machine learning (ML) model and obtain a set of predefined questions corresponding to the product requirement, based on the category associated with the product requirement, from a database. The plurality of processor-executable instructions, upon execution, may further cause the processor to determine an answer-value corresponding to each predefined question of the set of predefined questions, using a second pre-trained machine learning (ML) model and generate a test script based on the set of predefined questions and the answer value corresponding to each question of the set of questions.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating test scripts from product requirements, in accordance with an embodiment of the present disclosure.

FIG. 2 is a block diagram of a test script generating device showing one or more modules, in accordance with some embodiments.

FIG. 3 is a flowchart of a method of generating test script from product requirements, in accordance with some embodiments.

FIG. 4A illustrates an example product requirement, in accordance with some embodiments.

FIG. 4B illustrates a category into which the product requirement of FIG. 4A is classified into, in accordance with some embodiments.

FIG. 4C illustrates a set of predefined questions obtained based on the category of FIG. 4B, in accordance with some embodiments.

FIG. 4D illustrates answer values corresponding to the set of predefined questions of FIG. 4C, in accordance with some embodiments.

FIG. 4E illustrates a test script generated based on the set of predefined questions of FIG. 4C and the answer values of FIG. 4D corresponding to the set of questions, in accordance with some embodiments.

FIGS. 5A-5B illustrate a process flow diagram of an example process of generating test script from product requirements, in accordance with some embodiments.

FIG. 6 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The present subject matter provides for one or more techniques for automatic generation of test script from product requirements. An objective of the present subject matter is to overcome or reduce problems associated with the existing product testing by using the product requirement documents directly for Automated Test Script Generation (ATSG). Natural Language Processing (NLP) can be applied to extract information from the product requirement document, that can be then used for test script generation.

NLP is a fast-developing technology that has impressive scope in ATSG. NLP can be used to analyze the natural language of humans to understand the functional description of the products and their meaning. NLP further enables to extract logical functions that are written in plain language (such as English language). The extracted logical functions can be used to define test cases. And test cases can be converted to test scripts, which are executable by a test automation engine. The test automation engine is responsible to execute the tests on the products.

The ATSG may include the steps of (i) text classification (TC) and (ii) Question and Answering. The product requirements are classified into corresponding categories using the text classification technique. The Text classification may be performed using machine learning (ML) techniques that classify texts into different categories by analyzing their content (i.e. context) using the NLP. The texts are classified based on the complexity of requirements using a customized TC model. A TC model is deep learning neural network, which is trained to categories the requirements. Each category is further mapped to a set of questions. The questions obtained from the TC are send to the QA technique, where answers for the corresponding questions are detected. It uses a deep learning-based QA model to retrieve the information from the product requirement documents and prepare the answers. The answers describe variables and the value that needs to be set to test the requirements. After receiving answers from QA model, it is sent to a prewritten skeleton of the test script. It is the test script that will have place holder to populate the parameters and arguments. The test scripts have different labels to identify the corresponding location that needs to be filled. Finally, the skeleton test scripts in transformed to the actual test script with populated variables.

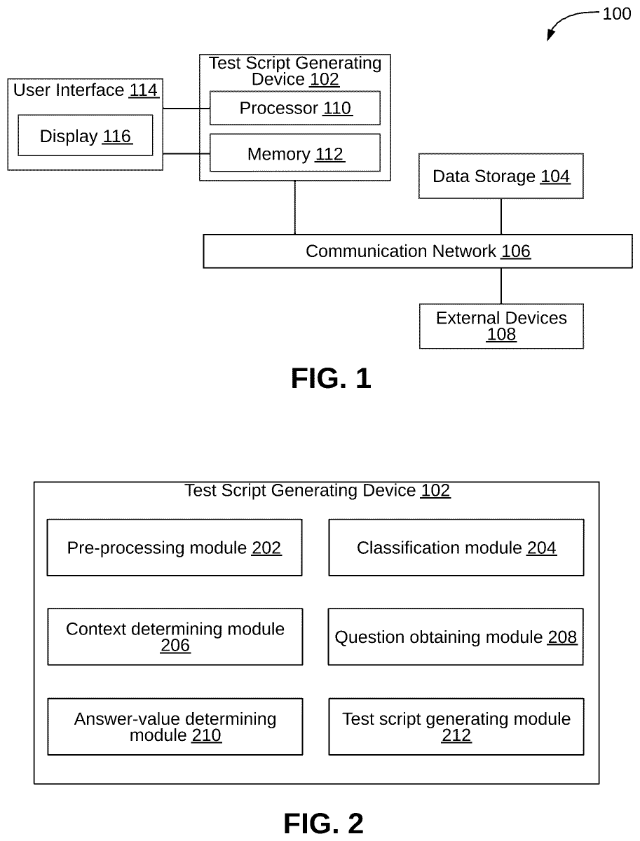

Referring now to FIG. 1, a block diagram of an exemplary system 100 for generating test script from product requirements is illustrated, in accordance with some embodiments of the present disclosure. The system 100 may implement a test script generating device 102. The test script generating device 102 may be a computing device having data processing capability. Examples of the test script generating device 102 may include, but are not limited to a desktop, a laptop, a notebook, a netbook, a tablet, a smartphone, a mobile phone, an application server, a web server, or the like. The system 100 may further include a data storage 104. Additionally, the test script generating device 102 may be communicatively coupled to an external device 108 for sending and receiving various data. Examples of the external device 108 may include, but are not limited to, a remote server, digital devices, and a computer system. A computing device, a smartphone, a mobile device, a laptop, a smartwatch, a personal digital assistant (PDA), an e-reader, and a tablet are all examples of external devices 108.

The test script generating device 102 may connect to the external device 108 over a communication network 106. The test script generating device 102 may connect to external device 108 via a wired connection, for example via Universal Serial Bus (USB).

The test script generating device 102 may be configured to perform one or more functionalities that may include classifying a product requirement into a corresponding category of a plurality of predefined categories, using a first pre-trained machine learning (ML) model and obtaining a set of predefined questions corresponding to the product requirement, based on the category associated with the product requirement, from a database. The one or more functionalities may further include determining an answer-value corresponding to each predefined question of the set of predefined questions, using a second pre-trained machine learning (ML) model and generating a test script based on the set of predefined questions and the answer value corresponding to each question of the set of questions.

To perform the above functionalities, the test script generating device 102 may include a processor 110 and a memory 112. The memory 112 may be communicatively coupled to the processor 110. the memory 112 may store a plurality of instructions, which upon execution by the processor 110, cause the processor to perform the above functionalities. The test script generating device 102 may further implement a user interface 114 that may further implement a display 116. Examples may include, but are not limited to a display, keypad, microphone, audio speakers, vibrating motor, LED lights, etc. The user interface 114 may receive input from a user and also display an output of the computation performed by the test script generating device 102.

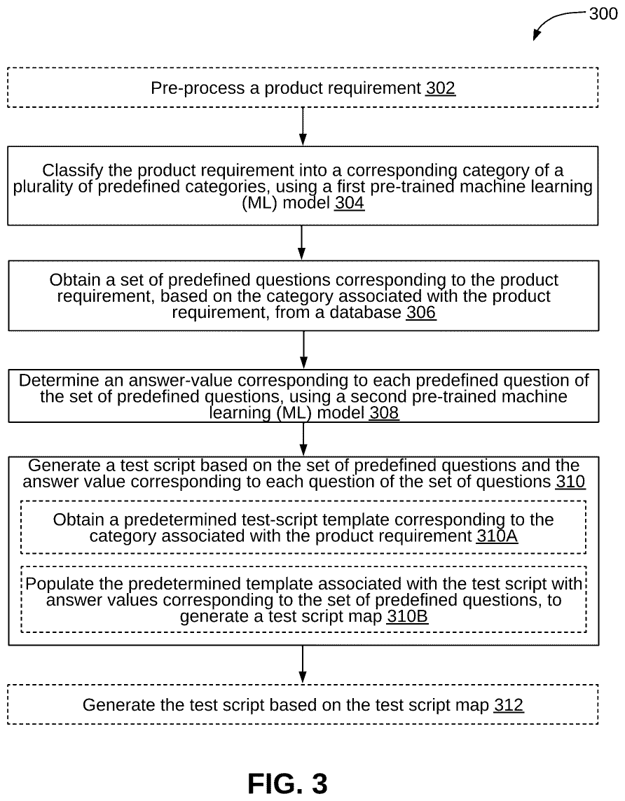

Referring now to FIG. 2, a block diagram of the test script generating device 102 showing one or more modules is illustrated, in accordance with some embodiments. In some embodiments, the test script generating device 102 may include a pre-processing module 202, a classification module 204, a context determining module 206, a question obtaining module 208, an answer-value determining module 210, and a test script generating module 212.

The pre-processing module 202 may be configured to pre-process the product requirements. For example, the pre-processing may include replacing a symbol within a text of the product requirement with a substitute text token.

The classification module 204 may classify the product requirement into a corresponding category of a plurality of predefined categories, using a first pre-trained machine learning (ML) model. In some embodiments, the product requirement may be classified into a corresponding category of the plurality of predefined categories based on a context associated with each of the one or more product requirements. To this end, the context determining module 206 may determine the context associated with each of the one or more product requirements using a natural language processing (NLP) model.

The question obtaining module 208 may obtain a set of predefined questions corresponding to the product requirement, based on the category associated with the product requirement, from a database. The answer-value determining module 210 may determine an answer-value corresponding to each predefined question of the set of predefined questions, using a second pre-trained machine learning (ML) model.

The test script generating module 212 may generate a test script based on the set of predefined questions and the answer value corresponding to each question of the set of questions. In some embodiments, to generate a test script, the test script generating module 212 may obtain a predetermined test-script template corresponding to the category associated with the product requirement. The test script generating module 212 may further populate the predetermined template associated with the test script with answer values corresponding to the set of predefined questions, to generate a test script map. The test script map may include one or more question values associated with each of the set of predefined questions and the answer value corresponding to each of the one or more question values associated with each of the set of predefined questions. The test script generating module 212 may therefore generate the test script based on the test script map.

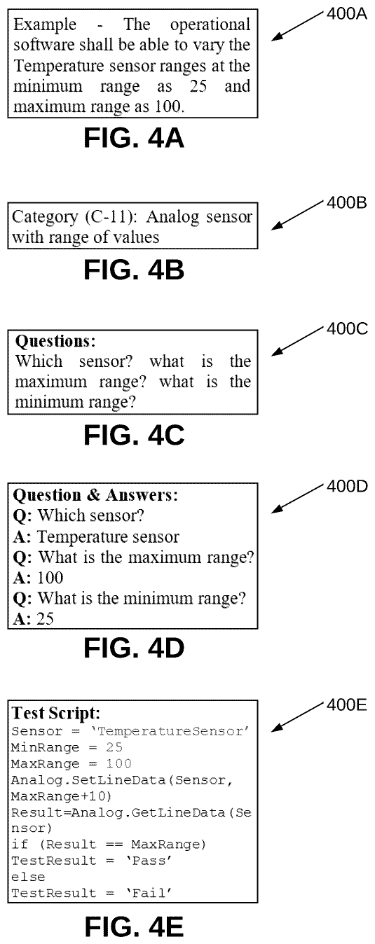

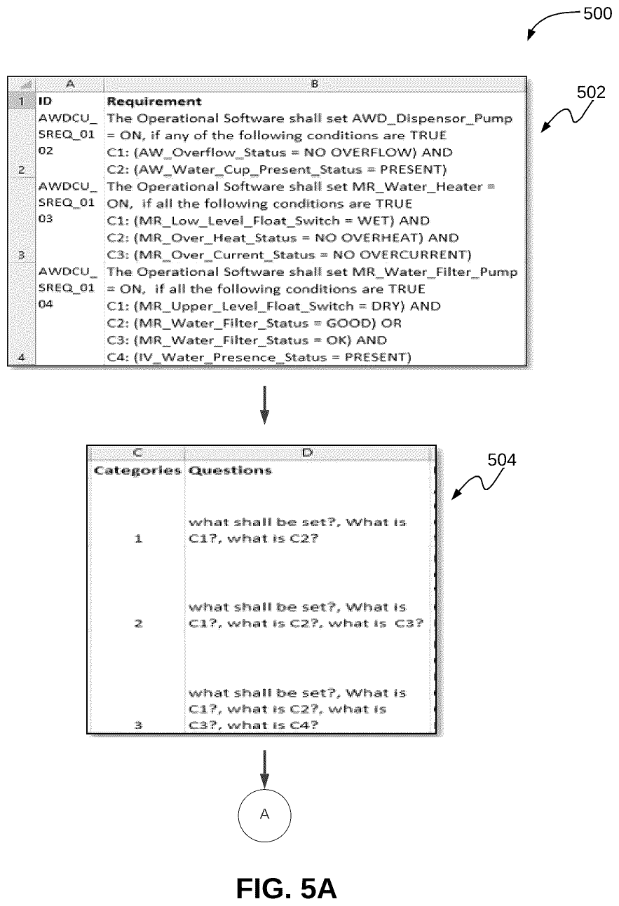

Referring now to FIG. 3, a flowchart of a method 300 of generating test script from product requirements is illustrated, in accordance with some embodiments. The method 300 may be performed by the test script generating device 102. The method 300 is explained in conjunction with FIGS. 4A-4D.

At step 302, in some embodiments, a product requirement may be pre-processed. The pre-processing, for example, may include replacing a symbol within a text of the product requirement with a substitute text token. It should be noted that the step 302 of pre-processing is optional, subject to the presence of the symbol within a text of the product requirement.

As will be appreciated by those skilled in the art, the quality of data (i.e. the text of the product requirement) is a crucial factor for accurately generating the test scripts. In some example embodiments, the product requirements may be required in English language. Further, symbols such as “=”, “@”, “$”, and “#” need to be identified and replaced with their equivalent English substitute text tokens, such as “equal to”, “at the rate”, “dollar”, and “hash”, respectively, for greater accuracy.

An example product requirement 400A is depicted in FIG. 4A. As shown in FIG. 4A, the example product requirement 400A includes the text “The operational software shall be able to vary the Temperature sensor ranges at the minimum range as 25 and maximum range as 100”.

At step 304, the product requirement may be classified into a corresponding category of a plurality of predefined categories, using a first pre-trained machine learning (ML) model. The product requirement may be classified into a corresponding category of the plurality of predefined categories based on a context associated with each of the one or more product requirements. In some embodiments, the context associated with each of the one or more product requirements may be determined using a natural language processing (NLP) model.

The product requirements may be classified into corresponding categories using a text classification model (for example, a machine learning (ML)-based model) that classifies the text into different categories by analyzing the content (i.e. context of the text), using natural language processing (NLP). The text may be classified based on the complexity of requirements, using any conventional text classification model. The text classification model may be a deep learning neural network (i.e. the first pre-trained ML model), which is trained to categorize the product requirements. The data corresponding to input and expected output of the first pre-trained ML model needs to be acquired. As such, for the first pre-trained ML model, the product requirement and corresponding category are set as input and output, respectively.

FIG. 4B shows a category 400B into which the product requirement 400A is classified into. For example, as shown in FIG. 4B, the category 400B is category “C-11” related to “Analog sensor with range of values”.

At step 306, a set of predefined questions corresponding to the product requirement may be obtained. The predefined questions may be obtained based on the category associated with the product requirement, from a database. For example, each category may be mapped to the set of predefined questions.

FIG. 4C shows a set of predefined questions 400C obtained based on the category 400B associated with the product requirement 400A. As shown, the set of predefined questions 400C include “Which sensor?”, “What is the maximum range?” and “What is the minimum range?”.

At step 308, an answer-value corresponding to each predefined question of the set of predefined questions may be determined, using a second pre-trained machine learning (ML) model. In other words, at step 308, answers corresponding to the set of predefined questions may be detected. For example, in some embodiments, in order to detect the answer-values, a second pre-trained ML model, i.e. different from the first pre-trained ML model may be used. Alternately, in some embodiments, the second pre-trained ML model may be the same as the first pre-trained ML model. The second pre-trained ML model may retrieve information from the product requirement documents and prepare the answer-values. The answer-values may describe variables and the values that need to be set, to test the product requirements. As such, the second pre-trained ML model may use the predefined questions and corresponding answers that need to be derived from the product requirements as output. After receiving answer-values, the answer-values may be sent to a prewritten skeleton (i.e. a predetermined template) of the test script (as explained in conjunction with steps 310A-310B).

The first ML model and the second ML model may be trained using training data based on supervisory training. Further, a pre-trained model or a new model can be trained for better accuracy. As will be understood, a pre-trained ML model is one which is already trained on data.

FIG. 4D shows answer values 400D corresponding to the set of predefined questions 400C. As shown, for the predefined question “Which sensor?” the corresponding answer value determined is “Temperature sensor”; for the predefined question “What is the maximum range?”, the corresponding answer value determined is “100”; and for the predefined question “What is the minimum range?”, the corresponding answer value determined is “25”.

At step 310, a test script may be generated based on the set of predefined questions and the answer value corresponding to each question of the set of questions. In some embodiments, in order to generate the test script, the method 300 may include additional steps 310A-310B. At step 310A, a predetermined test-script template corresponding to the category associated with the product requirement may be obtained. At step 310B, the predetermined template associated with the test script may be populated with answer values corresponding to the set of predefined questions, to generate a test script map. The test script map may include one or more question values associated with each of the set of predefined questions. The test script map may further include the answer value corresponding to each of the one or more question values associated with each of the set of predefined questions. The predetermined template may include place holders to populate various parameters and arguments. Further, the predetermined template may have different labels to identify the corresponding locations that need to be filled.

At step 312, the test script may be generated based on the test script map. As such, the predetermined template is transformed to an actual test script with populated variables.

FIG. 4E show a test script 400E generated based on the set of predefined questions 400C and the answer values 400D corresponding to each question of the set of questions 400C.

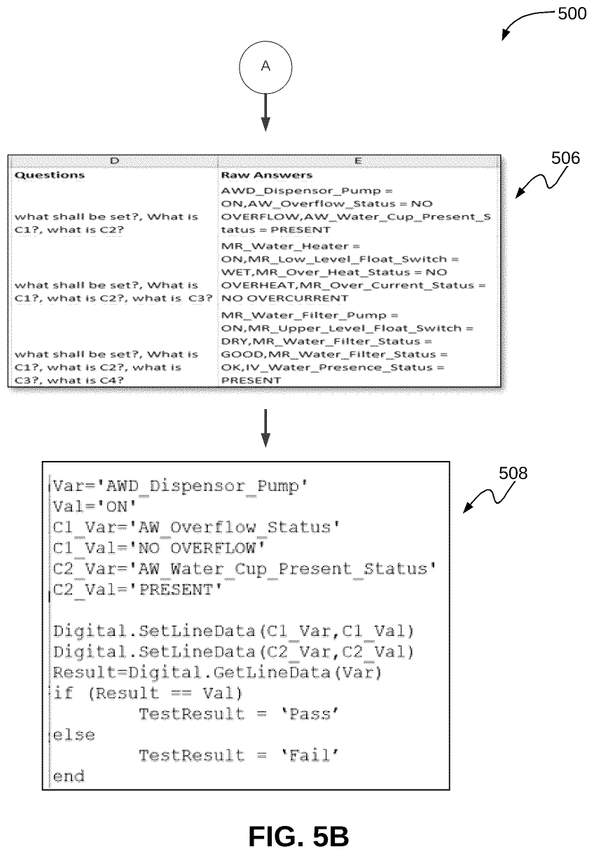

Referring now to FIGS. 5A-5B, a process flow diagram of an example process 500 of generating test script from product requirements is illustrated, in accordance with some embodiments. The process 500 is explained with respect to example functional requirements of a water dispenser.

At step 502, product requirements associated with the water dispenser are received. For example, as shown in FIG. 5, three different functional requirements describing the logical functions of the product may be considered.

At step 504, the product requirements are classified into a corresponding category of a plurality of predefined categories, using the first pre-trained machine learning (ML) model. The product requirements may be classified into a corresponding category of the plurality of predefined categories based on the context associated therewith. For example, the context associated with the product requirements may be determined using a Natural Language Processing (NLP) model. The text of the product requirements may be classified based on the complexity of product requirements, using any ML-based conventional text classification model. Further, at step 504, a set of predefined questions corresponding to the product requirements may be obtained. The predefined questions may be obtained based on the category associated with the product requirements, from a database. The product requirements may be categorized according to the complexity of the logic described by them. For example, logical condition “C-1” indicates “lesser complexity”, and logical condition “C-3” indicates “greater complexity”. Each category may have a set of predefined questions. In the example process 500, the number of logical conditions and the corresponding variables that need to be tested are queried using the predefined questions.

At step 506, an answer-value corresponding to each predefined question of the set of predefined questions may be determined, using the second pre-trained machine learning (ML) model. As such, answers corresponding to the set of predefined questions may be detected, at step 506. The answer-values may describe variables and the values that need to be set, to test the product requirements. As such, the second pre-trained ML model may use the predefined questions and corresponding answers that need to be derived from the product requirements as output. After receiving answer-values, the answer-values may be sent to a predetermined template of the test script.

As such, answers are extracted for the set of predefined questions from the requirement descriptions. For example, the answer for the first question “What shall be set?” enables to identify the variable name, and the values that needs to be tested. Similarly, the question “What is C1-4?” provides answers from the variables that need to be set and their corresponding values. The variables and the values are populated in the predetermined template of the test script.

At step 508, a test script is generated based on the set of predefined questions and the answer value corresponding to each question of the set of questions. In some embodiments, in order to generate the test script, first, the predetermined test-script template corresponding to the category associated with the product requirement may be obtained. Thereafter, the predetermined template associated with the test script may be populated with answer values corresponding to the set of predefined questions, to generate a test script map. The test script map may include one or more question values associated with each of the set of predefined questions. The test script map may further include the answer value corresponding to each of the one or more question values associated with each of the set of predefined questions. The predetermined template may include place holders to populate various parameters and arguments. Further, the predetermined template may have different labels to identify the corresponding locations that need to be filled. The test script may be generated based on the test script map. In other words, the predetermined template is transformed to an actual test script with populated variables.

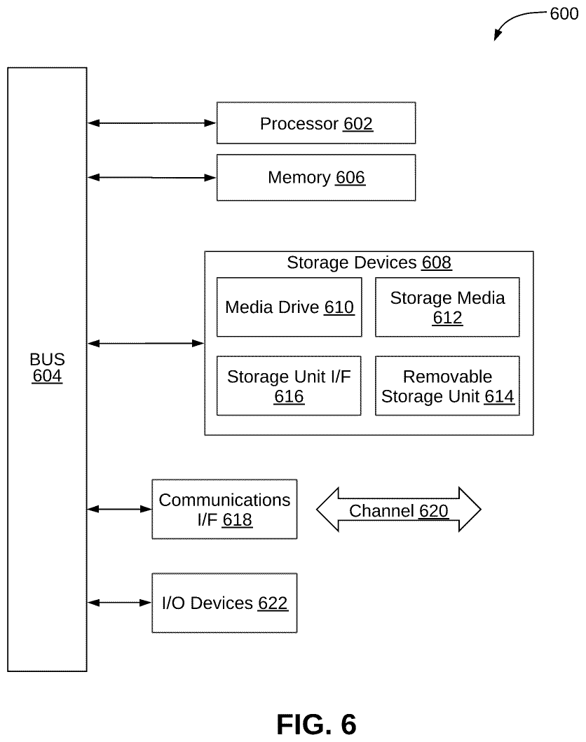

Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication media. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during the execution of instructions to be executed by processor 602. The computing system 600 may likewise include a read-only memory (“ROM”) or other static storage device coupled to bus 604 for storing static information and instructions for the processor 602.

The computing system 600 may also include storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 612 may include, for example, a hard disk, magnetic tape, flash drive, or other fixed or removable media that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro-USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

One or more techniques for generating test script from product requirements are disclosed. The above techniques do away with the requirement of Behavior-driven development (BDD) or keyword-based method to generate test script from the test cases. BDD requires creation of keywords and its corresponding test scripts manually. Instead, the techniques of the present disclosure directly generate the test scripts from the requirements, thereby ensuring comprehensive test coverage and lesser manual effort. Further, the techniques provide for creation of a test script template, and rely on predefined questions and answer-values to populate the variables to create a test script automatically from the test script template. As such, the product requirements or test cases can be written in the normal plain language (e.g. English language) while requiring minimal programming skills or product knowledge. Further, tester effort is significantly reduced since manual intervention is minimal. Furthermore, chances of errors induced due to manual work in defining variables and values for test scripts are reduced.

It is intended that the disclosure and examples be considered as exemplary only, with a true scope and spirit of disclosed embodiments being indicated by the following claims.

What is claimed is:

1. A method generating test script from product requirements, the method comprising:
classifying, by a test script generating device, a product requirement into a corresponding category of a plurality of predefined categories, using a first pre-trained machine learning (ML) model;
obtaining, by the test script generating device, a set of predefined questions corresponding to the product requirement, based on the category associated with the product requirement, from a database;
determining, by the test script generating device, an answer-value corresponding to each predefined question of the set of predefined questions, using a second pre-trained machine learning (ML) model; and
generating, by the test script generating device, a test script based on the set of predefined questions and the answer value corresponding to each question of the set of questions.

2. The method of claim 1, wherein the product requirement is classified into a corresponding category of the plurality of predefined categories based on a context associated with each of the one or more product requirements.

3. The method of claim 2, wherein the context associated with each of the one or more product requirements is determined using a natural language processing (NLP) model.

4. The method of claim 2, wherein generating the test script comprises:
obtaining a predetermined test-script template corresponding to the category associated with the product requirement;
populating the predetermined template associated with the test script with answer values corresponding to the set of predefined questions, to generate a test script map comprising:
one or more question values associated with each of the set of predefined questions; and
the answer value corresponding to each of the one or more question values associated with each of the set of predefined questions; and
generating the test script based on the test script map.

5. The method of claim 1, further comprising:
pre-processing the product requirement, the pre-processing comprising replacing a symbol within a text of the product requirement with a substitute text token.

6. A system for generating test script from product requirements, the system comprising:
a processor; and
a memory communicatively coupled to the processor, wherein the memory stores a plurality of processor-executable instructions, which upon execution by the processor, cause the processor to:
classify a product requirement into a corresponding category of a plurality of predefined categories, using a first pre-trained machine learning (ML) model;
obtain a set of predefined questions corresponding to the product requirement, based on the category associated with the product requirement, from a database;
determine an answer-value corresponding to each predefined question of the set of predefined questions, using a second pre-trained machine learning (ML) model; and
generate a test script based on the set of predefined questions and the answer value corresponding to each question of the set of questions.

7. The system of claim 6, wherein the product requirement is classified into a corresponding category of the plurality of predefined categories based on a context associated with each of the one or more product requirements.

8. The system of claim 6, wherein the context associated with each of the one or more product requirements is determined using a natural language processing (NLP) model.

9. The system of claim 6, wherein generating the test script comprises:
obtaining a predetermined test-script template corresponding to the category associated with the product requirement;
populating the predetermined template associated with the test script with answer values corresponding to the set of predefined questions, to generate a test script map comprising:
one or more question values associated with each of the set of predefined questions; and
the answer value corresponding to each of the one or more question values associated with each of the set of predefined questions; and
generating the test script based on the test script map.

10. The system of claim 5, wherein the processor-executable instructions further cause the processor to:
pre-processing the product requirement, the pre-processing comprising replacing a symbol within a text of the product requirement with a substitute text token.

11. A non-transitory computer-readable medium storing computer-executable instructions for generating test script from product requirements, the computer-executable instructions configured for:
classifying a product requirement into a corresponding category of a plurality of predefined categories, using a first pre-trained machine learning (ML) model;
obtaining a set of predefined questions corresponding to the product requirement, based on the category associated with the product requirement, from a database;
determining an answer-value corresponding to each predefined question of the set of predefined questions, using a second pre-trained machine learning (ML) model; and
generating a test script based on the set of predefined questions and the answer value corresponding to each question of the set of questions.

12. The non-transitory computer-readable medium of claim 11, wherein the product requirement is classified into a corresponding category of the plurality of predefined categories based on a context associated with each of the one or more product requirements.

13. The non-transitory computer-readable medium of claim 12, wherein the context associated with each of the one or more product requirements is determined using a natural language processing (NLP) model.

14. The non-transitory computer-readable medium of claim 12, wherein generating the test script comprises:
obtaining a predetermined test-script template corresponding to the category associated with the product requirement;
populating the predetermined template associated with the test script with answer values corresponding to the set of predefined questions, to generate a test script map comprising:
one or more question values associated with each of the set of predefined questions; and
the answer value corresponding to each of the one or more question values associated with each of the set of predefined questions; and
generating the test script based on the test script map.

15. The non-transitory computer-readable medium of claim 11, wherein the computer-executable instructions are further configured for:
pre-processing the product requirement, the pre-processing comprising replacing a symbol within a text of the product requirement with a substitute text token.
